(19) United States
(12) Patent Application Publication
(10) Pub. No.: US 2012/0152436 A1
(43) Pub. Date: Jun. 21, 2012

(54) Methods for Assembling Disposable Diaper Pants

(76) Inventor: Uwe Schneider, Cincinnati, OH (US)

(21) Appl. No.: 13/311,973

(22) Filed: Dec. 6, 2011

Related U.S. Application Data
(60) Provisional application No. 61/424,734, filed on Dec. 20, 2010.

(51) Int. Cl. B32B 38/18; B32B 37/10

(52) U.S. Cl. 156/66; 156/226

(57) ABSTRACT

A method for assembling diaper pants is disclosed. Each diaper pant may include a chassis and two side panels extending from the chassis. The side panels join a first waist region and a second waist region of the chassis. The method may include the steps of connecting first end regions of the side panels with a first waist region of the chassis, advancing the chassis in a machine direction, folding the chassis about its lateral axis, transferring the folded chassis to a drum comprising a first folding member and a second folding member, moving the first and second folding members toward each other and radially outward relative an outer surface of the drum to position second end regions of the side panels in contact with a second waist region of the chassis, and connecting second end regions of the side panels with the second waist region.

### CROSS REFERENCE TO RELATED APPLICATION

This application claims the benefit of U.S. Provisional application No. 61/424,734, filed on Dec. 20, 2010, which is incorporated herein by reference.

### FIELD OF THE INVENTION

The present disclosure generally relates to methods for assembling disposable absorbent articles, and more particularly relates to methods for assembling disposable diaper pants.

### BACKGROUND OF THE INVENTION

Disposable absorbent diapers configured to be donned like pants, in that to be donned they are pulled on over a wearer's feet and up the legs rather than wrapped directly about and fastened at the wearer's lower torso like an infant diaper, have been in the market for a number of years. Such products are often marketed as “training pants” intended for children who are walking, beginning to develop independence and dress themselves, and learning to control their bodily functions so that they can transition out of diapers and into underwear. Such training pants or diaper pants provide a toilet-training child with an underwear-like garment that he or she can learn to don himself or herself in the same manner as underpants, providing a new sense of accomplishment and independence, while still providing protection against accidents. Similar articles are marketed in larger sizes and intended for older children experiencing childhood enuresis, or adults experiencing incontinence.

Currently marketed designs of diaper pants are constructed from a rectangular or hourglass-shaped precursor chassis having a liquid impermeable, garment-facing backsheet, a liquid permeable, wearer-facing topsheet, and an absorbent core between the backsheet and the topsheet. The chassis of the typical design has front and rear waist regions and a crotch region between the waist regions, and respective front and rear pairs of side panels formed of a laterally, elastically stretchable and contractible stretch laminate, extending from each of the waist regions, with the respective front and rear side panels on each side then joined together at side seams to form a pant-like structure. The side panels provide for elastic hoop-wise expansion of the article to allow it to be pulled over body contours while being donned, and elastic hoop-wise contraction to hold the article comfortably and securely in place while being worn by a wearer.

In view of the importance of disposable diaper pants, methods of manufacturing and assembling the same should be improved.

### SUMMARY OF THE INVENTION

Methods for assembling diaper pants are disclosed herein. A method for assembling diaper pants is disclosed. Each diaper pant may include a chassis and two side panels extending from the chassis. The side panels join a first waist region and a second waist region of the chassis. The method may include the steps of connecting first end regions of the side panels with a first waist region of the chassis, advancing the chassis in a machine direction, folding the chassis about its lateral axis, transferring the folded chassis to a drum comprising a first folding member and a second folding member, moving the first and second folding members toward each other and radially outward relative an outer surface of the drum to position second end regions of the side panels in contact with a second waist region of the chassis, and connecting second end regions of the side panels with the second waist region.

In one form, a method may be configured for assembling disposable diaper pants, each diaper pant comprising a chassis, a first side panel, and a second side panel, each chassis comprising a topsheet, a backsheet, and an absorbent core disposed between the topsheet and the backsheet, each chassis comprising a first waist region longitudinally opposed to a second waist region, and a crotch region located between the first and second waist regions, and having a longitudinal axis and a lateral axis, the first and second side panels joining the first waist region and the second waist region to form a waist opening and a pair of leg openings. The method may include the steps of: connecting first end regions of the first and second side panels with the first waist region of the chassis; advancing the chassis in a machine direction on a first conveyor with the second waist region positioned as the leading portion of the chassis; folding the chassis about the lateral axis to position the second waist region into a facing relationship with the first waist region; transferring the folded chassis, with the crotch region positioned as the leading portion of the folded chassis, directly to a drum comprising an outer surface, a first folding member, and a second folding member, wherein the backsheet of the first waist region is in direct contact with the outer surface of the drum, and wherein the first and second side panels extend laterally outward from the first waist region with the first side panel positioned on the first folding member and the second side panel positioned on the second folding member; moving the first folding member and the second folding member toward each other and radially outward relative to the outer surface of the drum to position second end regions of the first and second side panels in contact with the second waist region of the chassis; and connecting the second end regions of the first and second side panels with the second waist region.

In another form, a method may be configured for assembling disposable diaper pants, each diaper pant comprising a chassis, a first side panel, and a second side panel, each chassis comprising a topsheet, a backsheet, and an absorbent core disposed between the topsheet and the backsheet, each chassis comprising a first waist region longitudinally opposed to a second waist region, and a crotch region located between the first and second waist regions, and having a longitudinal axis and a lateral axis, the first and second side panels joining the first waist region and the second waist region to form a waist opening and a pair of leg openings. The method may include the steps of: advancing the first and second side panels in a machine direction on a first conveyor; transferring the first and second side panels to a drum comprising an outer surface, a first folding member, and a second folding member, wherein the first and second side panels extend laterally outward from a central region of the outer surface with the first side panel positioned on the first folding member and the second side panel positioned on the second folding member; advancing the chassis in a machine direction on a first conveyor; folding the chassis about the lateral axis to position the second waist region into a facing relationship with the first waist region; transferring the folded chassis, with the crotch region positioned as the leading portion of the folded chassis, directly to the drum, wherein the backsheet of the first waist region is in direct contact with an outer surface of the drum and first end regions of the first and second side panels; moving the first folding member and the second folding member toward each other and radially outward relative to the outer surface of the drum to position second end regions of the first and second side panels in contact with the second waist region of the chassis; and connecting the second end regions of the first and second side panels with the second waist region.

### BRIEF DESCRIPTION OF THE DRAWINGS

FIG. 1 is a top view of a diaper pant in an unfolded configuration in accordance with one non-limiting embodiment of the present disclosure.

FIG. 2 is a top view of the diaper pant of FIG. 1 in a folded configuration, but with first and second side panels in an unfolded configuration in accordance with one non-limiting embodiment of the present disclosure.

FIG. 3 is a top view of the diaper pant of FIG. 1 in a folded configuration and with the first and second side panels in a folded configuration in accordance with one non-limiting embodiment of the present disclosure.

FIG. 4 is a top view of another diaper pant in an unfolded configuration in accordance with one non-limiting embodiment of the present disclosure.

FIG. 5 is a top view of yet another diaper pant in an unfolded configuration in accordance with one non-limiting embodiment of the present disclosure.

FIG. 6 is a top view of still another diaper pant in an unfolded configuration in accordance with one non-limiting embodiment of the present disclosure.

FIG. 7 is a top view of still another diaper pant in an unfolded configuration in accordance with one non-limiting embodiment of the present disclosure.

FIG. 8 is a top view of two diaper pants in an unfolded configuration before separation in accordance with one non-limiting embodiment of the present disclosure.

FIG. 9 is a schematic illustration of a diaper pant being assembled in accordance with one non-limiting embodiment of the present disclosure.

FIG. 10A is another schematic illustration of a diaper pant being assembled in accordance with one non-limiting embodiment of the present disclosure.

FIG. 10B is yet another schematic illustration of a diaper pant being assembled in accordance with one non-limiting embodiment of the present disclosure.

FIG. 10C is yet another schematic illustration of a diaper pant being assembled in accordance with one non-limiting embodiment of the present disclosure.

FIG. 11 is yet another schematic illustration of a diaper pant being assembled in accordance with one non-limiting embodiment of the present disclosure.

FIG. 12 is perspective view of a rotating drum used for folding side panels of a diaper pant in accordance with one non-limiting embodiment of the present disclosure.

FIG. 13 is a schematic illustration of a folding mechanism of the rotating drum of FIG. 12 in accordance with one non-limiting embodiment of the present disclosure.

### DETAILED DESCRIPTION OF THE INVENTION

The following term explanations may be useful in understanding the present disclosure:

The term “absorbent article” is used herein to refer to consumer products whose primary function is to absorb and retain soils and wastes. Non-limiting examples of absorbent articles include diapers, training pants, pull-on pant-type diapers, refastenable diapers or pant-type diapers, incontinence briefs and undergarments, diaper holders and liners, feminine hygiene garments such as panty liners, absorbent inserts, and the like.

The term “bi-fold” means the leading edge portion and the trailing edge portion of an article on a production line are brought together in a face-to-face configuration once the article is folded about a fold line extending laterally across the article as the article moves in the machine direction of travel.

The term “cross direction” (CD) is used herein to refer to a direction that is generally perpendicular to the machine direction.

The term “diaper” is used herein to refer to an absorbent article generally worn by infants, children, and incontinent persons about the lower torso.

The term “pant” (also referred to as “training pant”, “pre-closed diaper”, “diaper pant”, “pant diaper”, and “pull-on diaper”) refers herein to disposable absorbent articles having a continuous perimeter waist opening and continuous perimeter leg openings designed for infant, child, or adult wearers. A pant can be configured with a continuous or closed waist opening and at least one continuous, closed, leg opening as packaged, prior to the article being applied to the wearer. A pant can be preformed by various techniques including, but not limited to, joining together portions of the article using any refastenable and/or permanent closure member (e.g., seams, heat bonds, pressure welds, adhesives, cohesive bonds, mechanical fasteners, etc.). A pant can be preformed anywhere along the circumference of the article in the waist region (e.g., side fastened or seamed, front waist fastened or seamed, rear waist fastened or seamed or combinations thereof).

The term “disposable” is used herein to describe absorbent articles which generally are not intended to be laundered or otherwise restored or reused as an absorbent article (e.g., they are intended to be discarded after a single use and may also be configured to be recycled, composted or otherwise disposed of in an environmentally compatible manner).

The term “joined” encompasses configurations whereby an element is directly secured to another element by affixing the element directly to the other element, and configurations whereby an element is indirectly secured to another element by affixing the element to intermediate member(s) which in turn are affixed to the other element.

The term “lateral” refers to a direction running from a longitudinally extending side edge to a laterally opposing longitudinally extending side edge of an article and generally at a right angle to the longitudinal direction. Directions within 45 degrees of the lateral direction are considered to be “lateral.”

The term “longitudinal” means a direction running substantially perpendicular from a waist edge to a longitudinally opposing waist edge of an absorbent article when the article is in a flat out, uncontracted state, or from a waist edge to the bottom of the crotch, i.e. the fold line, in a bi-folded article. Directions within 45 degrees of the longitudinal direction are considered to be “longitudinal.”

The term “machine direction” (MD) is used herein to refer to the direction of material flow through a process. In addition, relative placement and movement of material can be described as flowing in the machine direction through a process from upstream in the process to downstream in the process.

Current disposable diaper pants present at least several challenges. Because the diaper pants are “disposable” and the industry is highly competitive (factors that exert downward pressure on pricing), the business of manufacturing disposable diaper pants requires large scale and production volume for success. Thus, in addition to product quality, performance, fit, appearance, and consumer satisfaction, cost and material conservation may be an ever-present and ever-important objective. Elastomeric materials used as components of side panels may be among the more expensive components of many current disposable diaper pant designs. Consequently, inclusion of such materials to any extent that is unnecessary to provide intended functions (e.g. elastic stretch and contraction) may be undesirable.

The amount of overall lateral hoop-wise expansion available in a disposable diaper pant is affected by the lateral width of the side panels (i.e., the greater the lateral width of the side panel, the greater the amount of lateral expansion that it will provide). Thus, the respective front and rear side panels must be of a sufficient lateral width to provide for the amount of lateral hoop stretch required for the intended wearer to easily and comfortably don the diaper pant. Generally, increasing stretch capability by increasing the lateral width of the side panels provides for easier and more comfortable donning On the other hand, once the diaper pant is donned and in wearing position on the wearer, contraction is required to provide a secure, neat fit and exudate containment functionality. If the side panels are excessively wide, the side panels may not be stretched enough in the wearing position to provide sufficient contractive securing tension, and an unacceptably loose/sloppy fit may result. Generally, decreasing the lateral width of the side panels may increase the snugness, neatness, and security of the fit and containment functionality. Thus, in designing side panels and selecting their width, competing and conflicting objectives are presented.

Further, the precursor front and rear side panels must have additional lateral width available to form the seams along which they are to be attached. The seams typically include a section of the side panels that is relatively fixed, such that it cannot serve to provide stretch capability. Thus, in one sense, the stretch capability of the portions of the side panel material (including the relatively expensive elastomeric materials) required for side seams is wasted. Considering the production volumes required for competitiveness in the market, this is not an insignificant factor.

Additionally, the typical chassis, and especially the liquid impermeable backsheet thereof, will be required to be of a certain lateral width at the front and rear waist regions in order to provide desired containment of urine or other liquid exudates, and a desired width of the envelope structure containing the absorbent core. The needed lateral width of the backsheet will take up substantial portions of the lateral waist circumference. This leaves only a smaller fraction of the overall waist band length (at the side-hip areas) available for side panels. In order to provide the stretch capability needed to strike the balance between the need for ease of donning and a secure fit, relatively high-performance elastomeric material is needed for the side panels—which is relatively expensive. Some designs have added elastically stretchable members and suitable accompanying construction to the rear and/or front waist regions to supplement waistband stretch capability. This approach, however, adds its own cost and complexity to the design.

Further, it is often desirable for a diaper pant to be quickly and easily removable (such as when soiled with exudates), without the necessity of having to pull the pant down over the wearer's legs and feet. For this reason, it may be desirable that portions of the pant are easily separable by the caregiver or wearer at one or more defined locations, so that it can be conveniently and neatly removed. One currently available design addresses this need by providing side seams held together only by strips of hook-type fastener components engaged with a compatible receiving material, which will allow relatively easy separation along the side seam when the caregiver or wearer applies requisite separating forces across the seam. However, this approach does not help with materials savings and in some circumstances may add cost and complexity to the design. Other design approaches have employed side seams in which the respective front and rear stretch panels are permanently bonded together. Although such approaches decrease the possibility of unintended separation, they also reduce the ease of removal.

In view of the foregoing, the design needs, and costs of materials typically used to make disposable diaper pants, a need exists for improvements that will conserve materials and improve lateral hoop-wise stretch performance and wearer/caregiver convenience. Furthermore, methods of manufacturing and assembling these disposable diaper pants are also needed.

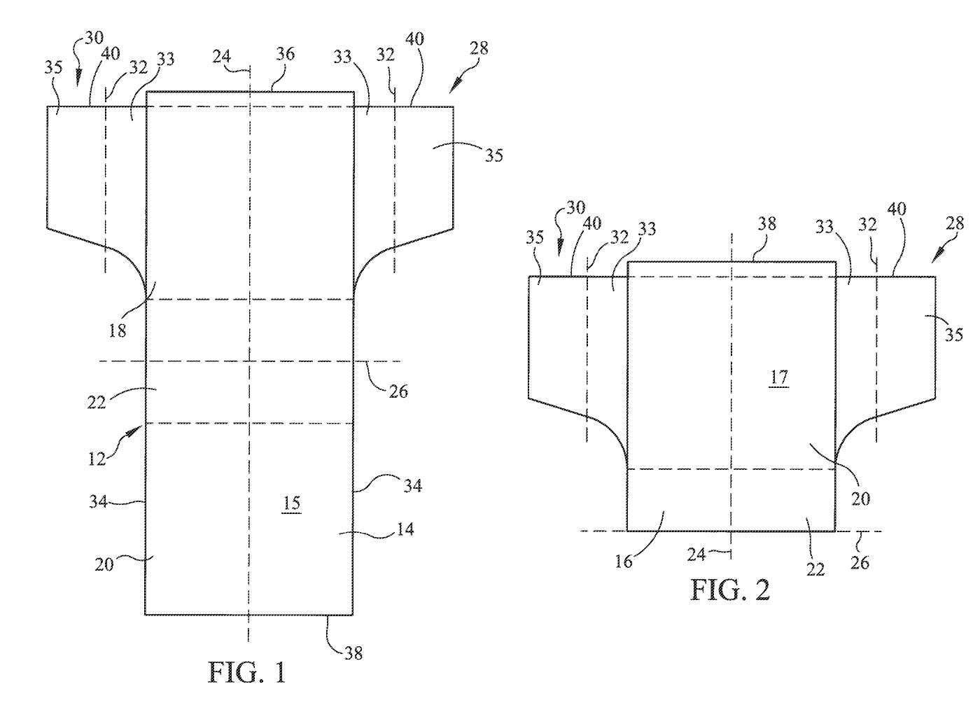

FIGS. 1-3 show an embodiment of a disposable diaper pant 10 or a chassis configured to be formed into a disposable diaper pant 10 is illustrated. The diaper pant 10 may comprise a chassis 12 comprising a topsheet 14 forming at least a portion of a wearer-facing surface 15, a backsheet 16 forming at least a portion of a garment-facing surface 17, and an absorbent core (not illustrated) disposed between the top sheet 14 and the backsheet 16. The chassis 12 may comprise a first waist region 18 longitudinally opposed to a second waist region 20 and a crotch region 22 located between the first and second waist regions 18 and 20. Each chassis 12 may have a longitudinal axis 24 and a lateral axis 26. In one embodiment, a first side panel 28 and a second side panel 30 may extend laterally outward from the first waist region 18 or, in other embodiments, the first side panel 28 and the second side panel 30 may extend laterally outward from the second waist region 20. The first side panel 28 and the second side panel 30 may join the first waist region 18 and the second waist region 20 to form a waist opening and a pair of leg openings in the diaper pant 10. The first side panel 28 and the second side panel 30 may each have a fold line 32 about which a second end region of a side panel may be folded laterally inward over a first end region of the side panel. The fold line 32 may be an indentation, a weakened area, a score mark or line, and/or a perforation, for example, in each side panel or may merely be where a fold will occur in each side panel.

In some embodiments, the topsheet 14 may comprise at least a portion of the wearer-facing surface 15, which is configured to be positioned against a portion of a wearer's body when the diaper pant 10 is donned. The topsheet 14 may be compliant, soft feeling, and non-irritating to the wearer's skin and may be elastically stretchable in one or more directions. Further, the topsheet 14 may be liquid pervious, permitting liquids (e.g., menses, urine, and/or runny feces) to penetrate through its thickness. Various topsheets may also comprise a hydrophilic material, for example, which is configured to draw bodily fluids into an absorbent core of the chassis 12 when these fluids are expelled from the body. A suitable topsheet 14 may be manufactured from a wide range of materials, such as woven and nonwoven materials, apertured or hydroformed thermoplastic films, apertured nonwovens, porous foams, reticulated foams, reticulated thermoplastic films, and/or thermoplastic scrims, for example. Suitable apertured films may comprise those described in U.S. Pat. Nos. 5,628,097, 5,916,661, 6,545,197, and 6,107,539, which are all incorporated by reference herein in their entireties. Apertured film topsheets typically may be pervious to bodily exudates, yet non-absorbent, and have a reduced tendency to allow fluids to pass back through and rewet the wearer's skin. Suitable woven and nonwoven materials may comprise natural fibers, such as, for example, wood or cotton fibers, synthetic fibers, such as, for example, polyester, polypropylene, or polyethylene fibers, or combinations thereof. If the topsheet 14 comprises fibers, the fibers may be spunbond, carded, wet-laid, meltblown, hydroentangled, or otherwise processed, for example, as is generally known in the art.

In some embodiments, the backsheet 16 may comprise at least a portion of the garment-facing surface 17, which is configured to be positioned against garments or undergarments when the diaper pant 10 is donned. The backsheet 16 may be impervious, or at least partially impervious, to fluids or body exudates (e.g., menses, urine, and/or runny feces) and may be manufactured from a thin plastic film, although other flexible liquid impervious materials may also be used. The backsheet 16 may prevent the body exudates or fluids absorbed and contained in an absorbent core of the diaper pant 10 from wetting articles which contact the diaper pant 10, such as bedsheets, pajamas, clothes, and/or undergarments, for example. The backsheet 16 may comprise a woven or nonwoven material, polymeric films, such as thermoplastic films of polyethylene or polypropylene, and/or a multi-layer or composite materials comprising a film and a nonwoven material (e.g., having an inner film layer and an outer nonwoven layer). In one embodiment, a suitable backsheet may comprise a polyethylene film having a thickness of from about 0.012 mm (0.5 mils) to about 0.051 mm (2.0 mils), for example. Examples of polyethylene films are manufactured by Clopay Corporation of Cincinnati, Ohio, under the designation BR-120 and BR-121, and by Tredegar Film Products of Terre Haute, Ind., under the designation XP-39385. In various embodiments, the backsheet 16 may be embossed and/or matte-finished to provide a more cloth-like appearance. Furthermore, the backsheet 16 may permit vapors to escape from the absorbent core of the diaper pant 10 (i.e., the backsheet 16 is breathable), while still preventing, or at least inhibiting, fluids or body exudates from passing through the backsheet 16. In one embodiment, the size of the backsheet 16 may be dictated by the size of the diaper pant 10 and the design or configuration of the diaper pant 10 to be formed, for example.

11924 10

In some embodiments, the absorbent core may be disposed between the topsheet 14 and the backsheet 16. In various embodiments, more than one absorbent core or more than one absorbent core layer may be provided in a single diaper pant, for example. The absorbent core(s) may be any suitable size or shape that is/are compatible with the diaper pant 10. Example absorbent structures for use as the absorbent core of the present disclosure that have achieved acceptance and commercial success are described in U.S. Pat. Nos. 4,610,678, 4,673,402, 4,888,231, and 4,834,735, which are all incorporated by reference herein in their entireties.

In some embodiments, suitable absorbent cores may comprise cellulosic airfelt material. For instance, such absorbent cores may comprise less than about 40%, 30%, 20%, 10%, 5%, or even 1% of the cellulosic airfelt material, as determined by weight. Additionally, such an absorbent core may be primarily comprised of an absorbent gelling material in amounts of at least about 60%, 70%, 80%, 85%, 90%, 95%, or even about 100%, as determined by weight. Furthermore, a portion of the absorbent core may comprise a microfiber glue (if applicable). Such absorbent cores, microfiber glues, and absorbent gelling materials are described in U.S. Pat. Nos. 5,599,335, 5,562,646, 5,669,894, 6,790,798, and 7,521,587 and in U.S. Patent Publication No. 2004/0158212, which are all incorporated by reference herein in their entireties.

In some embodiments, although not illustrated, the chassis 12 of the diaper pant 10 may comprise longitudinally extending and laterally opposing leg cuffs that are disposed on the wearer-facing surface 15 of the chassis 12. The leg cuffs may comprise one or more elastic gathering members disposed at or adjacent a proximal edge thereof. In addition to the elastic gathering members, one or more of the leg cuffs may comprise one or more elastic strands disposed at or adjacent a distal edge thereof. The elasticized leg cuffs may comprise several embodiments for reducing the leakage of body exudates or fluids in the leg regions. The elasticized leg cuffs are sometimes referred to as leg bands, barrier cuffs, elastic cuffs, or gasketing cuffs, for example. Suitable elasticized leg cuffs may comprise those described in U.S. Pat. Nos. 3,860,003, 4,909,803, 4,695,278, 4,795,454, 4,704,115, and 4,909,803, and U.S. Patent Publication No. 2009/0312730, which are all incorporated by reference herein in their entireties. In one embodiment, the leg cuffs may be formed by folding portions of the chassis 12 laterally inward, i.e., toward the longitudinal axis 24, to form both the respective leg cuffs and the side edges 34 of the chassis 12. In other embodiments, the leg cuffs may be formed by attaching an additional layer or layers to the chassis 12 at or adjacent to each of the respective side edges 34 of the chassis 12. In one embodiment, the chassis 12 may also comprise other elastics disposed adjacent the side edges 34, which may cause the pant 10 to form into a “U” shape when allowed to relax, thereby pulling the wearer-facing surface 15 of the first waist region 18 toward the wearer-facing surface 15 of the second waist region 20.

In some embodiments, although not illustrated, the diaper pant 10 may comprise an elasticized waistband. In one embodiment, the elasticized waistband may provide improved fit and containment and may be configured to elastically expand and contract laterally to dynamically fit a wearer's waist. The elasticized waistband may extend longitudinally inwardly from a waist edge of the diaper pant 10. In one embodiment, the diaper pant 10 may have two elasticized waistbands, one positioned in the second waist region 20 and one positioned in the first waist region 18, although other pant embodiments may be constructed with a single elasticized waistband. The elasticized waistband may be constructed in a number of different configurations including those described in U.S. Pat. Nos. 4,515,595 and 5,151,092, both of which are incorporated by reference herein in their entireties.

In some embodiments, the elasticized waistbands may comprise materials that have been “prestrained” or “mechanically prestrained” (i.e., subjected to some degree of localized pattern mechanical stretching to permanently elongate the material). The materials may be prestrained using suitable deep embossing techniques. In other embodiments, the materials may be prestrained by directing the material through an incremental mechanical stretching system as described in U.S. Pat. No. 5,330,458. The materials may then be allowed to return to their substantially untensioned condition, thus forming a zero strain stretch material that is extensible, at least up to the point of initial stretching. Examples of zero strain materials are disclosed in U.S. Pat. Nos. 2,075,189, 3,025,199, 4,107,364, 4,209,563, 4,834,741, and 5,151,092.

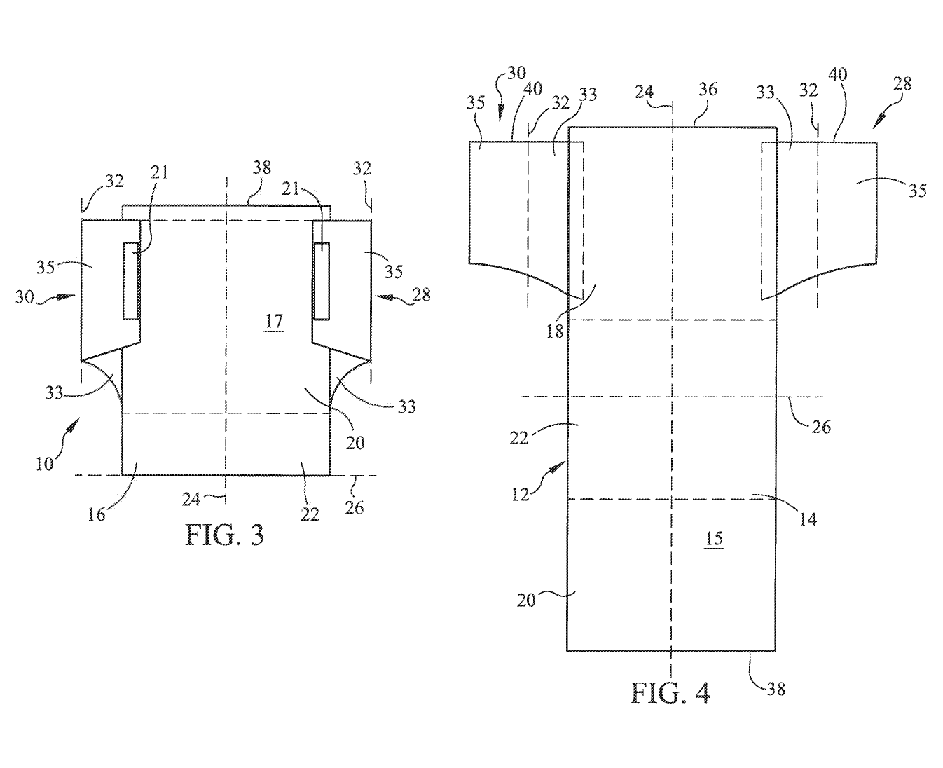

In some embodiments, referring to FIGS. 1 and 2 for example, the diaper pant 10 may comprise the first and second side panels 28 and 30 attached at or adjacent the side edges 34 of the chassis 12 in one of the first waist region 18 or the second waist region 20. In various embodiments, each side panel 28 and 30 may either be a discrete separate component affixed to the chassis 12 or may comprise a unitary piece of material that is neither divided nor discontinuous with an element of the chassis 12, for example, a backsheet, a topsheet, or a leg cuff. In other various embodiments, a pair of laterally opposed side panels 28 and 30 may be attached adjacent the laterally opposing side edges 34 of the chassis 12 in the first waist region 18. In one embodiment, the first and second side panels 28 and 30 may both be formed of a single component that may be attached to the backsheet 16 of the first waist region 18. In other various embodiments, the single component forming the first and second side panels 28 and 30 may be attached to the topsheet 14 of the first waist region 18, for example.

In some embodiments, the chassis 12 may comprise first and second laterally extending and longitudinally opposing end edges 36 and 38. The first end edge 36 may be positioned in the first waist region 18 and the second end edge 38 may be positioned in the second waist region 20. When the chassis 12 is folded about its lateral axis 26, the first end edge 36 may be positioned in a face-to-face orientation, or in a substantially face-to-face orientation, with the second end edge 38.

A simplified version of the assembly of the diaper pant 10 is illustrated in FIGS. 1-3. In FIG. 1, the chassis 12 is in an unfolded configuration and the first and second side panels 28 and 30 are in an unfolded configuration. The first and second side panels 28 and 30 may each be defined by the fold line 32 into first end regions 33 and second end regions 35. The first end regions 33 of the first and second side panels 28 and 30 may be connected to the first waist region 18. In one embodiment, the first and second side panels 28 and 30 may be connected to the garment-facing surface 17 of the first waist region 18, although such side panels may also be connected to the wearer-facing surface 15 of the first waist region 18, for example. In FIG. 2, the chassis 12 has been folded (i.e., bi-folded) about the lateral axis 26, such that the first waist region 18 is in a face-to-face orientation with the second waist region 20 and the first and second side panels 28 and 30 remain in the unfolded configuration. In FIG. 3, the second end regions 35 of the first and second side panels 28 and 30 are folded laterally inward toward the longitudinal axis 24 about the fold line 32 and are connected to the second waist region 20 using a bond 21, such a permanent bond, for example, or other suitable method of attachment. Some suitable methods of attachment of the second end regions 35 to the second waist region 20 comprise heat bonding, pressure bonding, and the use of adhesives or cohesives, for example. In various embodiments, the second end regions 35 may be removably or refastenably connected to the second waist region 20 using hook and loop fasteners, for example. In one embodiment, the second end regions 35 may be connected to the garment-facing surface 17 of the second waist region 20 to form a waist opening and two leg openings in the diaper pant 10. If the chassis 12 was folded about its lateral axis 26 after the second end regions 35 were folded about the fold line 32, then the second end regions 35 may be connected to the wearer-facing surface 15 of the second waist region 20.

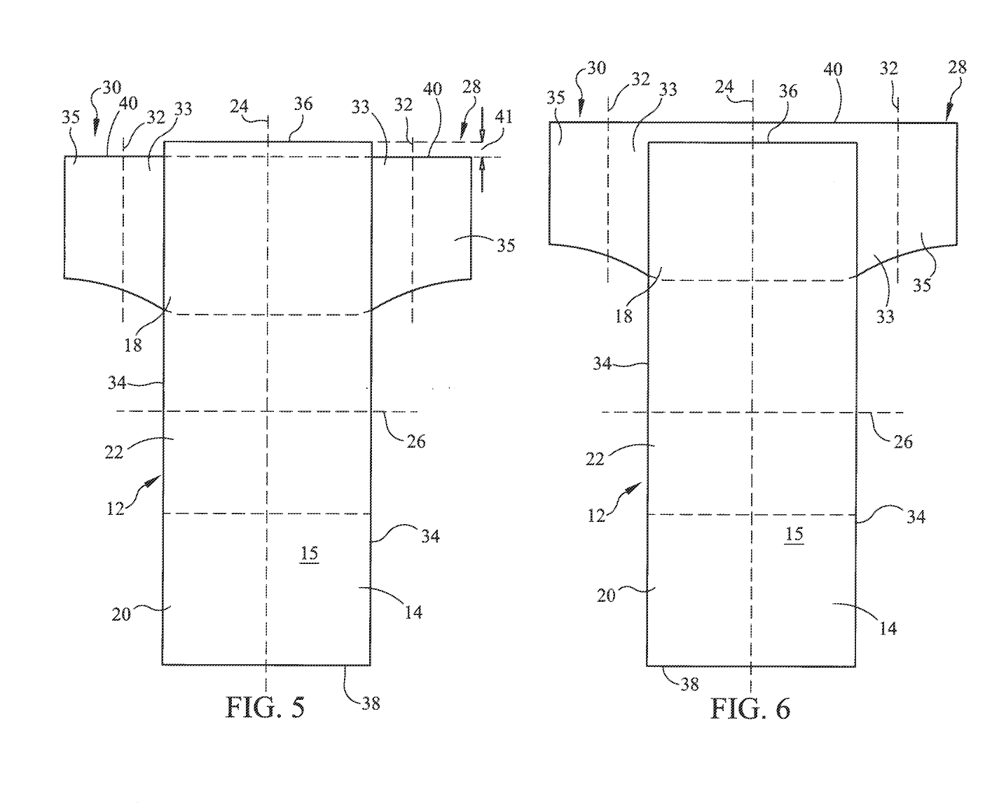

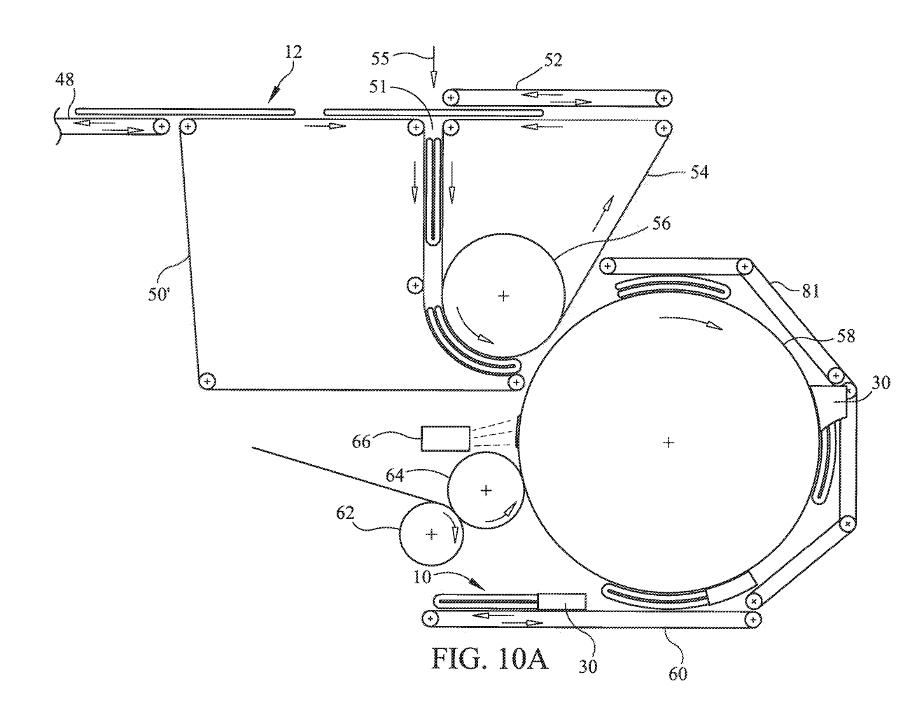

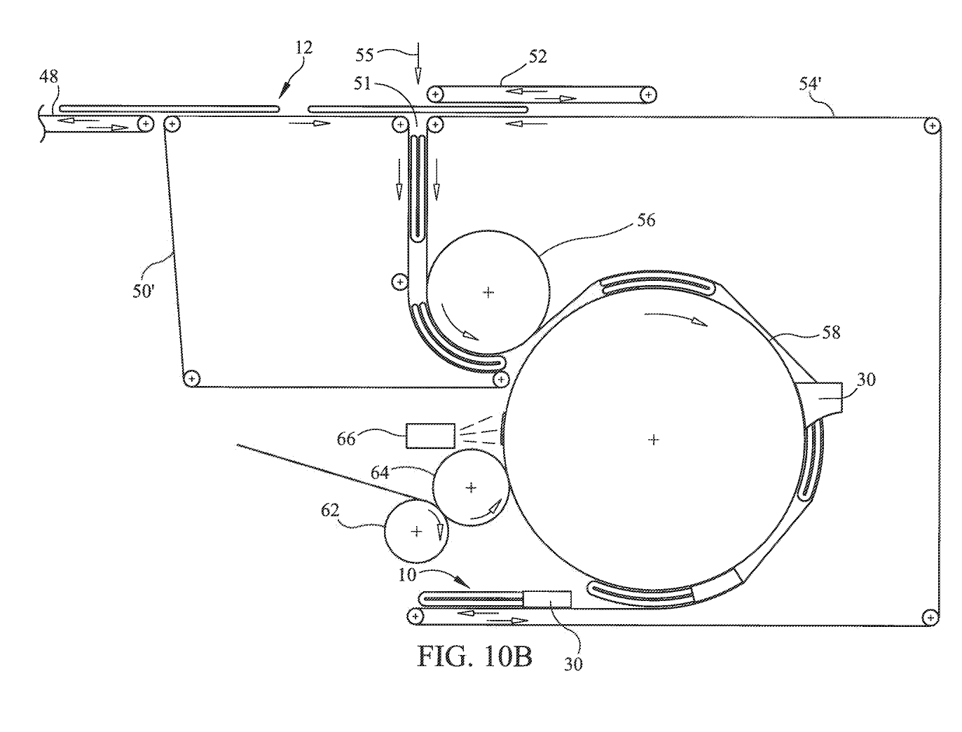

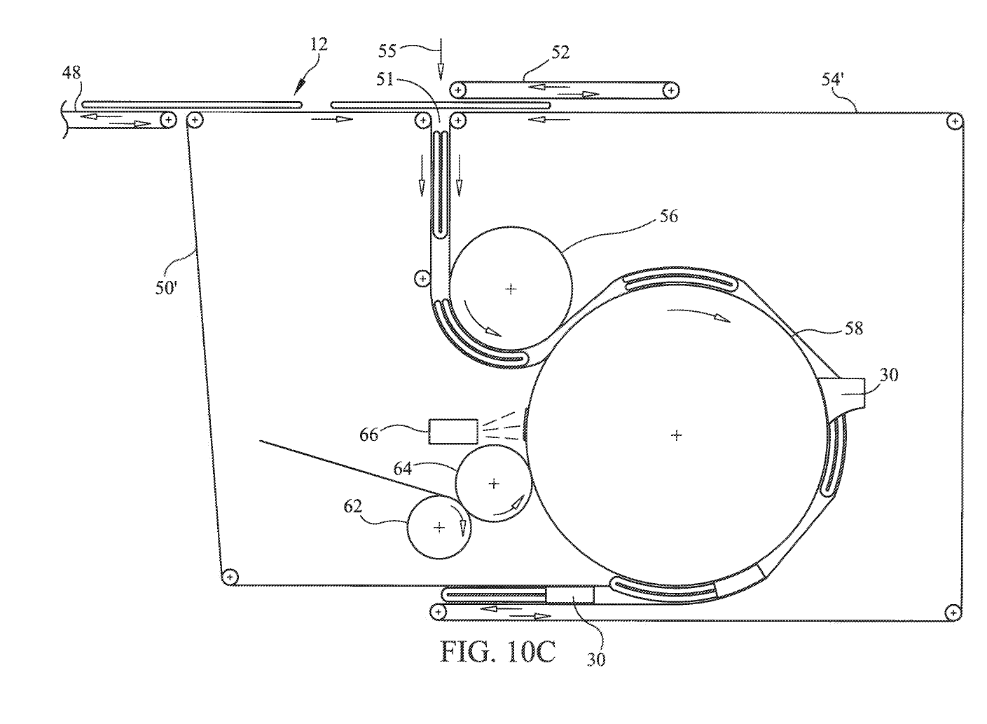

In some embodiments, referring to FIGS. 1-5, the first and second side panels 28 and 30 may each comprise an end edge 40 and the chassis 12 may comprise the first end edge 36 in the first waist region 18. When the first and second side panels 28 and 30 are connected to the first waist region 18, the first end edge 36 may extend more distally with respect to the lateral axis 26 than the end edges 40 thereby forming a top hat 41 (see e.g., FIG. 5). In some instances, the top hat 41 may be undesirable from an aesthetic standpoint. In FIGS. 1-3 and 5, the first and second side panels 28 and 30 are formed from a single component that comprises the end edge 40, while in FIG. 4 the first and second side panels 28 and 30 are formed from separate components each comprising an end edge 40. In one embodiment, referring to FIG. 6, the single component forming the first and second side panels 28 and 30 may comprise an end edge 40 and the chassis 12 may comprise the first end edge 36 in the first waist region 18. When the first and second side panels 28 and 30 are connected to the first waist region 18, the end edge 40 may extend more distally with respect to the lateral axis 26 than the first end edge 36. In such an embodiment, the single component forming the first and second side panels 28 and 30 may be cut and positioned suitably to land on or engage the first waist region 18 of the chassis 12 in the position illustrated in FIG. 6. Such positioning on the chassis 12 of the single component forming the first and second side panels 28 and 30 is discussed in greater detail below with respect to FIGS. 10A-10C.

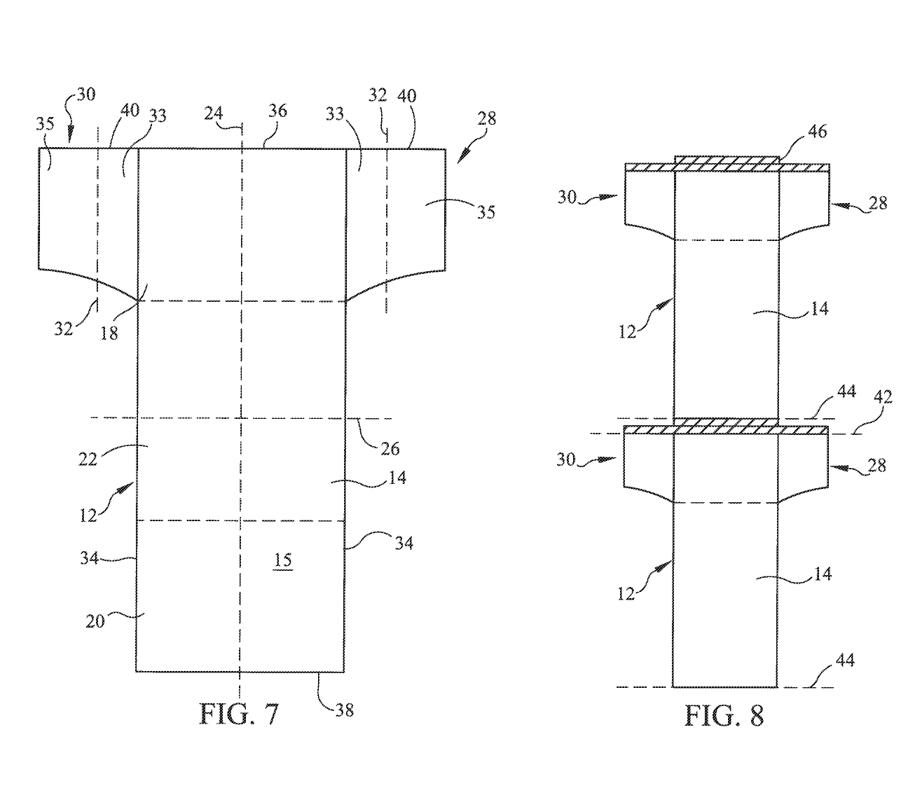

In some embodiments, referring to FIGS. 7 and 8, the single component forming the first and second side panels 28 and 30 may comprise an end edge 40 and the chassis 12 may comprise the first end edge 36 in the first waist region 18. When the first and second side panels 28 and 30 are attached to the first waist region 18, the end edge 40 may extend to the same extent as the first end edge 36 with respect to the lateral axis 26. Referring to FIG. 8, such a chassis 12 may be formed by cutting or trimming, in the cross-direction, along cut line 42. A second cut may be made along cut line 44 and then the excess material 46 may be removed. Such cutting steps may reduce the chance that the first end edge 36 of the first waist region 18 extends beyond the end edge 40 of the single component forming the first and second side panels 28 and 30 for aesthetic reasons, for example. In such a fashion, the top hat 41 (FIG. 5) may also be eliminated.

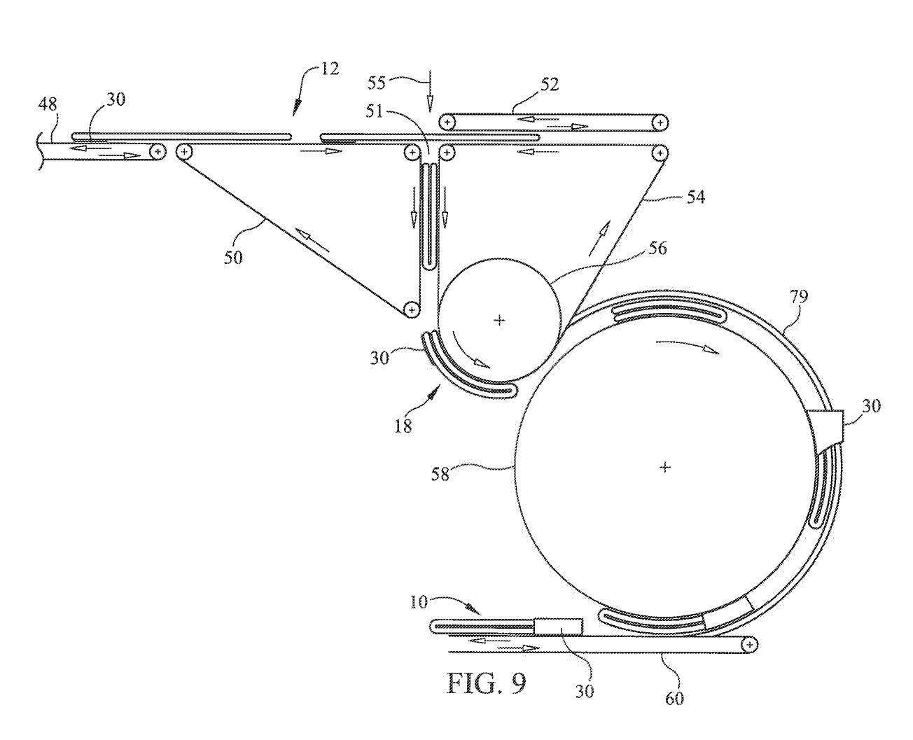

In some embodiments, referring to FIG. 9, the unfolded chassis 12 with the first and second side panels 28 and 30 connected to the first waist region 18 may be advanced in a machine direction on a conveyor 48 and a first conveyor 50 with the second waist region 20 leading. The conveyor 48 and/or the first conveyor 50 may comprise an endless belt. The conveyor 48 and the first conveyor 50 may comprise vacuum zones or ports configured to apply a vacuum force to at least a portion of the chassis 12 to hold the chassis 12 thereto. In other various embodiments, other retaining members and/or processes may be used to hold the chassis 12 to the conveyor 48 and the first conveyor 50. This retaining of the chassis 12 may be released at an appropriate time, such as when the chassis 12 is about to be transferred from one conveyor to another or to a drum. As discussed above, the first and the second side panels 28 and 30 may be formed of a single component or may each be formed of separate components. In any event, the first end regions 33 of the first and second side panels 28 and 30 may be permanently, removably, and/or refastenably connected to the first waist region 18 on either the wearer-facing surface 15 or the garment-facing surface 17. As the chassis 12 is advanced along the first conveyor 50 in the machine direction, the second waist region 20, and possibly a portion of the crotch region 22, may come into contact with a second conveyor 52. The conveyor 48 and the first conveyor 50 may contact the garment-facing surface 17 of the chassis 12 and the second conveyor 52 may contact the wearer-facing surface 15 of the chassis 12. The second conveyor 52 may comprise similar means as the conveyor 48 and the first conveyor 50 to hold the chassis 12 thereto. After the chassis 12 is advanced on the second conveyor 52 to, or about to, the lateral axis 26, a tucker blade (indicated by arrow 55) may contact the chassis 12 at or proximate to the lateral axis 26 on the wearer-facing surface 15 of the crotch region 22. Suitable tucker blades are disclosed in U.S. Pat. Nos. 4,519,596, 4,650,173, and 7,617,656, which are all incorporated by reference herein in their entireties. The tucker blade forces the chassis 12 to bi-fold about the lateral axis 26 and release from the second conveyor 52 when the chassis 12 is advanced into a nip 51 formed intermediate the first conveyor 48 and a third conveyor 54. In other various embodiments, any retaining force placed upon the chassis 12 by the second conveyor 52 may be released when the tucker blade contacts the chassis 12 in the crotch region 22. After bi-folding of the chassis 12, the second waist region 20 may be positioned in a facing relationship with the first waist region 18 and the first end edge 36 may be aligned with, or substantially aligned with, the second end edge 38. In such a configuration, the wearer-facing surface 15 of the first waist region 18 may be in a face-to-face relationship with the wearer-facing surface 15 of the second waist region 20.

In some embodiments, still referring to FIG. 9, as the folded chassis 12 travels into the nip 51 formed between the first conveyor 50 and the third conveyor 54, the chassis 12 will reach the end of the first conveyor 50 and any vacuum or other retaining force on the chassis 12 applied by the first conveyor 50 may be released. This release of vacuum or other retaining force may allow the chassis 12 to be retained by the third conveyor 54 as the vacuum or other retaining force provided to the chassis 12 by the third conveyor 54 may not yet be released. The folded chassis 12 may then travel around a transfer drum 56 while still positioned on the third conveyor 54. The transfer drum 56 may transfer the folded chassis 12 to a rotating drum 58 and release its vacuum or other retaining force prior to or during the transfer. Regardless of how the chassis 12 is bi-folded, the rotating drum 58 will receive a bi-folded chassis. It is to be appreciated that various other suitable methods of bi-folding a chassis, such as drum folding processes, for example, as described below, before providing the chassis 12 to the rotating drum 58 are within the scope of the present disclosure.

In some embodiments, referring to FIGS. 9, 12, and 13, the rotating drum 58 may receive a garment-facing surface 17 of the first waist region 18 and a portion of the crotch region 22 of the folded chassis 12. The rotating drum 58 is configured to fold, rotate, and/or pivot the first and second side panels 28 and 30 at or about at the fold line 32 to land the second end regions 35 of the first and second side panels 28 and 30 on the garment-facing surface 17 of the second waist region 20. The folded chassis 12, when positioned at about the 12 o'clock position on the rotating drum 58 may have its second end regions 35 of the first and second side panels 28 and 30 in an unfolded configuration, as illustrated in FIG. 1. In such a configuration, the plane of the wearer-facing surface 15 of the second end regions 35 of the first and second side panels 28 and 30 may be parallel to, or substantially parallel to, the plane of the garment-facing surface 17 of the second waist region 20. At about the 3 o'clock positioned on the rotating drum 58, the second end regions 35 of the first and second side panels 28 and 30 may be pivoted or rotated laterally inward about 90 degrees about the fold line 32 into a partially folded position. In such a configuration, the plane of the wearer-facing surface 15 of the second end regions 35 of the first and second side panels 28 and 30 may be perpendicular to, or substantially perpendicular to, the plane of the garment-facing surface 17 of the second waist region 20. At the 6 o'clock position on the rotating drum 58, the second end regions 35 of the first and second side panels 28 and 30 will be pivoted or rotated about 180 degrees about the fold line 32 into a fully folded position. In such a configuration, the wearer-facing surface 15 of the second end regions 35 of the first and second side panels 28 and 30 will be in a face-to-face relationship with the garment-facing surface 17 of the second waist region 20. The positions on the rotating drum 58 of 12 o'clock, 3 o'clock, and 6 o'clock are merely example positions. It is to be appreciated that other suitable positions on the drum 58 for the folding of the side panels are within the scope of the present disclosure. The second end regions 35 of the first and second side panels 28 and 30 may then be connected to, attached to, bonded to, adhered to, and/or otherwise engaged with the garment-facing surface 17 of the second waist region 20. The connection may be permanent, refastenable, or releasable. Suitable connection, attachment, bonding, and/or adhering techniques may include heating, melting, bonding, gluing, ultrasonic and hot air bonding, hook and loop fastening, and/or other various connection, attachment, and/or bonding techniques, for example. Additional details regarding the rotating drum 58 are described below. The pant diaper 10 may then be transferred onto a fourth conveyor 60 upon release of vacuum or retaining force on the pant diaper 10 by the rotating drum 58. In one embodiment, the connection between the second end regions 35 of the first and second side panels 28 and 30 to the second waist region 20 may take place on the fourth conveyor 60 or on the rotating drum 58.

In some embodiments, the bi-folded chassis 12 may be held or retained to the outer surface 78 of the rotating drum 58 using vacuum forces, other suitable retaining members, mechanical members, guides, and/or conveyors, for example. The rotating drum 58 may comprise vacuum zones and/or ports to apply a vacuum force to the garment-facing surface 17 of the first waist region 18 and a portion of the garment-facing surface 17 of the crotch region 22 to maintain the first waist region 18 and the portion of the crotch region 22 in contact with the outer surface 78 of the rotating drum 58 during rotation. In one embodiment, referring to FIG. 9, a guide 79 may be positioned at least partially around the rotating drum 58 and spaced from the outer surface 78 of the rotating drum 58. The guide 79 may be used to maintain the chassis 12 in the bi-folded configuration. In one embodiment, the guide 79 may be comprised of a material having a low coefficient of friction, such that the guide 79 may slidably engage the garment-facing surface 17 of the second waist region 20 and optionally a portion of the crotch region 22 to maintain the wearer-facing surface 15 of the second waist region 20 in a face-to-face orientation with the wearer-facing surface 15 of the first waist region 18. The guide 79 may have a lateral width smaller than the lateral width of the chassis 12, such that the first and second side panels 28 and 30 may be folded without contacting the guide 79. In other various embodiments, referring to FIG. 10A, a conveyor assembly 81 or a single conveyor may be used in place of the guide 79 to accomplish a similar result of maintaining the chassis 12 in the bi-folded configuration. Such a conveyor may allow the chassis 12 to be advanced in the machine direction between the outer surface 78 of the rotating drum 58 and the conveyor 81. In various embodiments, the guide 79 and the conveyor assembly 81 may hold the second waist region 20 of the chassis 12 in a facing relationship with the first waist region 18. Various guides, conveyors, and/or conveyor assemblies may also be used to maintain the second waist region 20 in a face-to-face relationship with the first waist region 18 while the chassis 12 is on the transfer drum 56.

In some embodiments, referring to FIGS. 10A-10C, the chassis 12 may not be connected to the first and second side panels 28 and 30 (either as a single component or as multiple components) until after the chassis 12 has been transferred to the rotating drum 58, as illustrated in FIG. 6, for example. In such an embodiment, a cutting drum or knife 62 and an anvil drum 64 may be positioned such that they can cut and apply the first and second side panels 28 and 30 to the rotating drum 58 at about the 9 o'clock position, for example. The knife 62 and the anvil drum 64 may apply the first and second side panels 28 and 30, or the single component forming the first and second side panels 28 and 30, to the rotating drum 58 using a cut and slip technique. A cut and slip technique is an operation for achieving spacing between discrete components. An example operation for achieving spacing between discrete components is disclosed in U.S. Pat. No. 5,702,551, which is incorporated by reference herein in its entirety. Other types of operations and equipment that may be used to cut and space discrete lengths of components are disclosed in U.S. Pat. No. 6,811,019, which is incorporated by reference herein in its entirety.

In some embodiments, an adhesive supplying apparatus 66, such as a spray nozzle, for example, may be positioned proximate to the transfer drum 56. The adhesive supplying apparatus 66 may supply an adhesive, such as glue, for example, to a portion of the first waist region 18, such as the garment-facing surface 17 of the first waist region 18 proximate to the first end edge 36, for example. In other various embodiments, the adhesive supplying apparatus 66 may be positioned to spray the adhesive onto the first and second side panels 28 and 30, after the first and second side panels 28 and 30 are positioned on the drum 58. In such an embodiment, when the chassis 12 is transferred onto the rotating drum 58, the backsheet 16 of the first waist region 18 may be in direct contact with the outer surface 78 of the rotating drum 58 and the first end regions 33 of the first and second side panels 28 and 30, such that the first end regions 33 may be permanently or releasably connected or bonded to the backsheet 16 of the first waist region 18. It is to be appreciated that in some embodiments, hot air may be used to connect the first and second side panels 28, 30 with the first waist region 18 instead of or in addition to using adhesive supply apparatus 66 to supply adhesive. In such a configuration, the rotating drum 58 may be configured to direct hot air from inside the rotating drum 58 to overlapped portions of the side panels 28, 30 and the first waist region 18 of the chassis 12 to melt bond the side panels 28, 30 with the chassis 12.

The placement of the first and second side panels 28 and 30 onto the rotating drum 58 may be suitably timed with the frequency of a chassis 12 being positioned onto the rotating drum 58, such that the first end regions 33 of the first and second side panels 28 and 30 may be suitably positioned to be permanently or releasably connected to or bonded to the first waist region 18. The rotating drum 58 may then fold the second end regions 35 of the first and second side panels 28 and 30, as described above with respect to FIG. 9.

In some embodiments, referring to FIGS. 10A-10C, various conveyors may be configured to maintain and/or hold the second waist region 20 in a face-to-face relationship with the first waist region 18 before and/or after the chassis 12 is transferred to the rotating drum 58. In various embodiments, referring to FIG. 10A, a first conveyor 50′ may surround a portion of the transfer drum 56 to maintain or hold the first waist region 18 and the second waist region 20 in a face-to-face relationship and prevent, or at least inhibit, the chassis 12 from unfolding, or at least partially unfolding, before or during transfer to the folding drum 58. The chassis 12 may be maintained or held in the bi-folded configuration while on the rotating drum 58 using a conveyor assembly 81, for example. In other embodiments, the chassis 12 may be maintained or held in the bi-folded configuration, while on the rotating drum 58 using a guide, such as guide 79 of FIG. 9, for example. The conveyors illustrated in FIGS. 10A-10C, may also be used in the embodiment disclosed in FIG. 9.

In some embodiments, referring to FIG. 10B, the first conveyor 50′ may be used in conjunction with a third conveyor 54′. The third conveyor 54′ may surround a portion of the rotating drum 58 to maintain or hold the first waist region 18 and the second waist region 20 of the chassis 12 in a face-to-face orientation while the chassis 12 is positioned on the rotating drum 58. In such an embodiment, the chassis 12 may be positioned between a portion of the third conveyor 54′ and an outer surface of the rotating drum 58. In one embodiment, the third conveyor 54′ may be used in place of the fourth conveyor 60 and may surround a portion of the transfer drum 56. Such a third conveyor 54′ may prevent, or at least inhibit, the chassis 12 from unfolding, or at least partially unfolding while on the rotating drum 58.

In some embodiments, referring to FIG. 10C, a first conveyor 50″may surround a portion of the transfer drum 56 and may surround a portion of the rotating drum 58 to maintain the first waist region 18 and the second waist region 20 in a face-to-face relationship while the chassis 12 travels around a portion of the transfer drum 56 and a portion of the rotating drum 58. The chassis 12 may travel about the rotating drum 58 intermediate the first conveyor 50″ and the third conveyor 54′.

By providing the conveyors, guides, and/or conveyor assemblies of the present disclosure, the first waist region 18 and the second waist region 20 may be held in a face-to-face relationship while the chassis 12 travels around a portion of the transfer drum 56 and travels around a portion of the rotating drum 58. Further, the chassis 12 does not need to be manipulated after the bi-folding operation and may be transferred directly to the rotating drum 58 without additional steps, manipulation, and/or rotation of the chassis 12. Also, through the use of the methods of the present disclosure, the crotch region 22 forms the leading portion of the diaper pant 10 as it separated or transferred from the rotating drum 58 for easy packaging with the crotch region 22 leading.

One publication, WO 2010/089964, discloses a method of bi-folding and then side panel folding for absorbent articles. At least two main disadvantages of the process described in this publication exist. First, if the absorbent article is to be placed upon the side panel folding drum with the crotch region leading, the side panels will be difficult to control during bi-folding and maintaining the absorbent article in the bi-folded configuration will also be difficult. Given the required orientation of the side panels on the side panel folding drum (i.e., with the side panels underneath the bi-folded chassis), it is inherent to this configuration that the first waist region, including the side panels, has to be on the leading side as it is transferred onto the bi-folding drum. In the bi-folded configuration, prior to exiting the bi-folding drum, the side panels have to be on the outside of the bi-folded absorbent article. Due to this requirement of orientation, the side panels have to be lifted off of the bi-folding drum (verses remaining on the surface of the bi-folding drum) during the bi-folding process. This makes controlling the absorbent articles difficult. Second, if the absorbent article is to be placed upon the folding drum with the waist regions leading, the absorbent article will be removed from or transferred from the folding drum with the waist regions leading and then will need to be reoriented for packaging, which generally requires that the crotch region be leading. The present disclosure overcomes the disadvantages of this publication by maintaining better control on the side panels during bi-folding and side panel folding, by maintaining the chassis in the bi-folded positioned, and by eliminating reorienting steps before or after side panel folding.

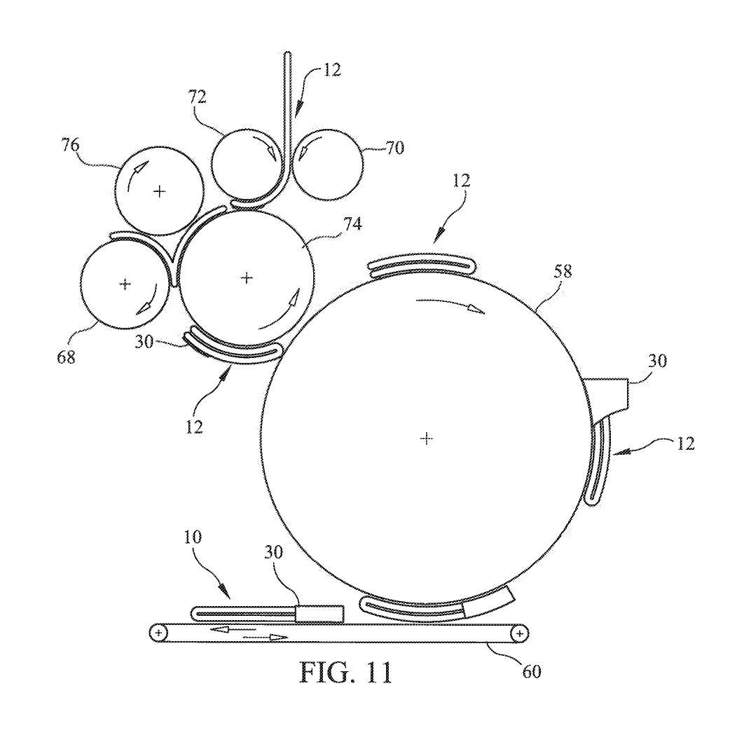

In some embodiments, referring to FIG. 11, the chassis 12 may be folded using a drum bi-folding technique. In such an embodiment, a first conveyor may comprise a folding drum 68. In such an embodiment, the chassis 12, in an unfolded configuration, may be advanced between two rolls 70 and 72 onto a transfer drum 74. The chassis 12, in such an embodiment, may be retained to any of the various drums by vacuum forces or other suitable methods. The chassis 12 may then be advanced until about ½ of the chassis 12 (i.e., the first waist region 18 and a portion of the crotch region 22 most proximal to the first waist region 18) is in contact with an alignment drum 76. The other ½ of the chassis 12 may remain on the transfer drum 74. In one embodiment, the direction of rotation of all of the drums is illustrated in FIG. 11. The ½ of the chassis 12 on the alignment drum 76 may then be transferred to the folding drum 68 by the alignment drum 76 releasing its vacuum force on the chassis 12 and by the folding drum 68 applying a vacuum force to the chassis 12. The opposite direction of rotation of the transfer drum 74 and the folding drum 68 may cause the wearer-facing surface 15 of the first waist region 18 to be positioned in a face-to-face relationship with the wearer-facing surface 15 of the second waist region 20. In such a configuration, the chassis 12 will be folded about its lateral axis 26 into a folded configuration and then be transferred by the transfer drum 74 to the rotating drum 58 with the crotch region of the chassis 12 in a leading position. The rotating drum 58 may fold the first and second side panels 28 and 30 and transfer the chassis 12 to the fourth conveyor 60 as described above with respect to FIG. 9. Suitable drum bi-folding techniques for diaper pants are disclosed in U.S. Patent Publication Nos. U.S. 2009/0098995A1 and U.S. 2009/0094941A1, U.S. Provisional patent application No. 61/322,333, filed Apr. 9, 2010, and U.S. Provisional patent application Nos. 61/364,604, 61/364,610, 61/364,616, and 61/364,626, all filed on Jul. 15, 2010, which are all incorporated by reference herein in their entireties. In one embodiment, the chassis 12 in FIG. 11 (although not illustrated) may be maintained in the bi-folded position on the rotating drum 58 using a guide, like guide 79, or a conveyor assembly, like conveyor assembly 81, for example. In other various embodiments, the chassis 12 may be maintained in the bi-folded position through the use of vacuum forces or an adhesive or other bond between the wearer-facing surface 15 of the first waist region 18 and the wearer-facing surface 15 of the second waist region 20, for example.

Referring to FIGS. 9-11, although each chassis 12 of the diaper pants 10 is illustrated as being advanced through the machinery in a particular direction, the chassis 12 may also be advanced through the machinery in an opposite direction (180 degree rotation). In other various embodiments, first end regions of first and second side panels may be connected to the second waist region of a chassis and the second end regions of the first and second side panels may be folded about a fold line and connected to the first waist region of a chassis using the same machinery. It is to be appreciated that other variations of the orientation of the diaper pants when being run through the machinery.

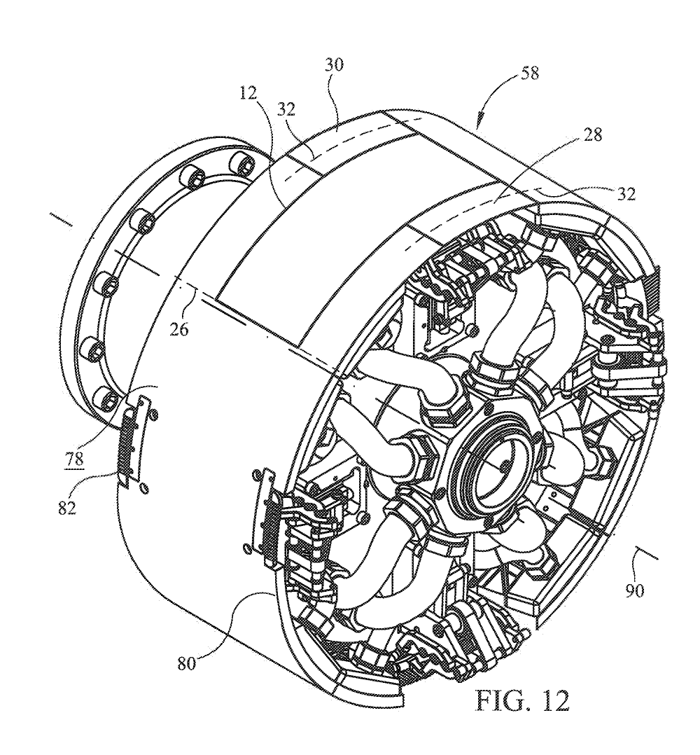

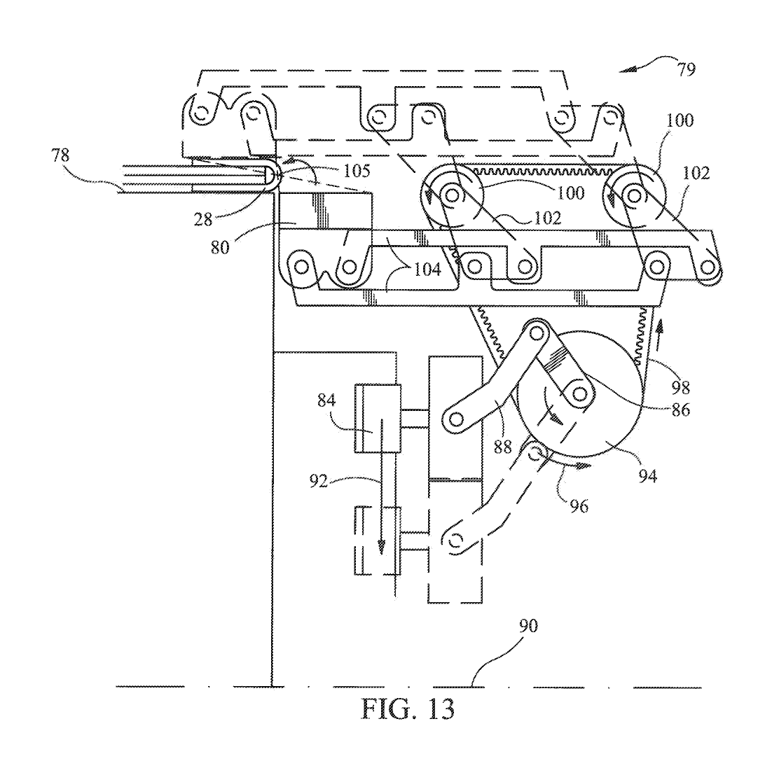

The folding drum 58 will now be described in greater detail. In one embodiment, referring to FIGS. 12 and 13, the folding drum 58, which is configured for high-speed folding of side panels, is illustrated. In various embodiments, the folding drum 58 may comprise an outer surface 78, a first folding member 80, and a second folding member 82. Each folding member 80 and 82 may be operatively engaged with or connected to a folding mechanism 79 comprising a cam follower 84. The first folding member 80 may laterally oppose the second folding member 82 on the rotating drum 58 and the first and second folding members 80 and 82 may be configured to move, pivot, and/or rotate toward and away from each other and radially outward and inward relative to the outer surface 78. In various embodiments, multiple pairs of first and second folding members 80 and 82 may be provided on the rotating drum 58. A pair of first and second folding members 80 and 82 is generally provided for each pant diaper receiving area on the rotating drum 58. For example, if a rotating drum can hold four pant diapers 10 at once, four pairs of first and second folding members 80 and 82 may be provided on the folding drum 58, such that the first and second side panels 28 and 30 of each pant diaper 10 may be folded.

In some embodiments, the chassis 12 may be situated on the folding drum 58, such that the backsheet 16 or the garment-facing surface 17 of the first waist region 18 and a portion of the crotch region 22 is in direct contact with the outer surface 78 of the folding drum 58, and such that the first and second side panels 28 and 30 extend laterally outward from the first waist region 18 with at least a portion of the first side panel 28 positioned on the first folding member 80 and with at least a portion of the second side panel 30 positioned on the second folding member 82. In one embodiment, the second end regions 35, or portions thereof, of the first and second side panels 28 and 30 may be positioned on the first and second folding members 80 and 82, respectively. In various embodiments, the first and second folding members 80 and 82 are not attached to the outer surface 78 of the rotating drum 58 and are movable, rotatable, and/or pivotable relative to the outer surface 78 through the use of the folding mechanisms 79, which each comprise linkages that may be operatively connected to a cam follower 84. The first and second folding members 80 and 82 may move, fold, pivot, and/or rotate the second end regions 35 of the first and second side panels 28 and 30 in the cross direction. In various embodiments, the side panels maybe folded, pivoted, and/or rotated about a virtual axis formed on the first and second side panels 28 and 30. In one embodiment, a primary linkage 86 may be operatively attached by a suitable pivot arm 88 to the cam follower 84, relative to an axis 90 of rotation of the rotating drum 58. Upon rotation of the rotating drum 58 about the axis of rotation 90, the cam follower 84 may move in a direction as indicated by arrow 92 or a first radial direction towards the axis of rotation 90. The radial motion of the cam follower 84 inwardly with respect to axis 90, may initiate the folding motion of the first and second folding members 80 and 82 (only the first folding member 80 is illustrated in FIG. 13). More specifically, as the cam follower 84 moves, the primary linkage 86 may rotate a belt drive 94 to rotate in the direction indicated by arrow 96. The belt drive 94 may move a belt 98, which thereby turns at least one drive roller 100, which turns an associated linkage connector 102, which itself is operatively connected to a linkage 104 which comprises a cooperating pair of links that are configured to facilitate an about 180 degree fold-over motion of the first folding member 80. Other supporting links, shafts, bearings, and the like, which are not necessarily shown, may be configured in known ways to complete the first and second folding members 80 and 82. It may be desirable to design the belt drive 94 to have a diameter exactly twice the diameter of the drive roller 100, such that as belt drive 94 rotates through an arc of 90 degrees, the drive roller 100 rotates through 180 degrees. After the first and second folding members 80 and 82 position the second end regions 35 onto the second waist region 20 for connection to the second waist region 20, the first and second folding members 80 and 82 may be pivoted away from each other and back into the position illustrated in FIG. 12 by moving the cam follower 84 in a second radial direction.

In some embodiments, still referring to FIGS. 12 and 13, the first folding member 80 may also be configured to retain, hold, and/or otherwise stabilize the first side panel 28 during the folding motion. Likewise, the second folding member 82 may also be configured to retain, hold, and/or otherwise stabilize the second side panel 30 during the folding motion (although the second folding member 82 is not illustrated in FIG. 13 for clarity in illustration). In various embodiments, the first folding member 80 may have vacuum ports defined therein to which a negative pressure or vacuum may be applied. In this manner, the first side panel 28 may be held in position on the first folding member 80 by vacuum or suction forces. In one embodiment, the vacuum or suction forces may only be applied to second end regions 35 of the first and second side panels 28 and 30. Once the first side panel 28 or the second end region 35 of the first side panel 28 has been folded about the fold line 32 or otherwise, the vacuum, suction, and/or other retaining force may be removed from the first folding member 80 to release the hold on the first side panel 28 or the second end region 35 of the first side panel 28. The same may occur with the second side panel 30. Vacuum forces may be applied using various techniques, such as suitable arrangements of pumps, tubes, and vacuum ports, for example. Other methods of retaining or stabilizing web, elastic, and/or side panel materials may also be used. For example, the first folding member 80 may have a light-tack adhesive applied to a surface thereof, such that the second end region 35 of the first side panel 28 may be removably adhered in place during the folding process. The same may occur with the second folding member 82. In one embodiment, a positive pressure may be created in the vacuum ports of the first and second folding members 80 and 82 to separate the first and second side panels 28 and 30 or the second end regions 35 of the first and second side panels 28 and 30 from the first and second folding members 80 and 82 after folding about the fold line 32. Additional details regarding rotating drum 58, the folding mechanisms 79, and the first and second folding members 80 and 82 may be found in U.S. Pat. No. 7,368,027 and U.S. Patent Publication No. 2003/0088227, both of which are incorporated by reference herein in their entireties.

It is to be appreciated that the methods of assembly of diaper pants specifically described herein and illustrated in the accompanying drawings are non-limiting example embodiments. The features illustrated or described in connection with one non-limiting embodiment may be combined with the features of other non-limiting embodiments. Such modifications and variations are intended to be included within the scope of the present disclosure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for assembling disposable diaper pants, each diaper pant comprising a chassis, a first side panel, and a second side panel, each chassis comprising a topsheet, a backsheet, and an absorbent core disposed between the topsheet and the backsheet, each chassis comprising a first waist region longitudinally opposed to a second waist region, and a crotch region located between the first and second waist regions, and having a longitudinal axis and a lateral axis, the first and second side panels joining the first waist region and the second waist region to form a waist opening and a pair of leg openings, the method comprising the steps of:
connecting first end regions of the first and second side panels with the first waist region of the chassis;
advancing the chassis in a machine direction on a first conveyor with the second waist region positioned as the leading portion of the chassis;
folding the chassis about the lateral axis to position the second waist region into a facing relationship with the first waist region;
transferring the folded chassis, with the crotch region positioned as the leading portion of the folded chassis, directly to a drum comprising an outer surface, a first folding member, and a second folding member, wherein the backsheet of the first waist region is in direct contact with the outer surface of the drum, and wherein the first and second side panels extend laterally outward from the first waist region with the first side panel positioned on the first folding member and the second side panel positioned on the second folding member;
moving the first folding member and the second folding member toward each other and radially outward relative to the outer surface of the drum to position second end regions of the first and second side panels in contact with the second waist region of the chassis; and
connecting the second end regions of the first and second side panels with the second waist region.

2. The method of claim 1, further comprising the step of holding the second waist region of the chassis in the facing relationship with the first waist region.

3. The method of claim 2, wherein the holding step further comprises advancing the folded chassis between one of a conveyor and a guide and the outer surface of the drum.

4. The method of claim 2, wherein the holding step occurs before the transferring step.

5. The method of claim 2, wherein the holding step occurs after the transferring step.

6. The method of claim 1, further comprising the step of moving the first and second folding members away from each other after the second end regions of the first and second side panels are connected with the second waist region.

7. The method of claim 1, wherein the second end regions of the first and second side panels are permanently connected with the second waist region.

8. The method of claim 7, wherein the second end regions of the first and second side panels are permanently connected with the second waist region using one of an adhesive, a cohesive, heat, and pressure.

9. The method of claim 1, wherein the second end regions of the first and second side panels are refastenably connected with the second waist region.

10. The method of claim 9, wherein the second end regions of the first and second side panels are refastenably connected with the second waist region using hook and loop fasteners.

11. The method of claim 1, wherein the first end regions of the first and second side panels are permanently connected with the first waist region.

12. The method of claim 1, wherein the first end regions of the first and second side panels are refastenably connected with the first waist region.

13. The method of claim 1, comprising applying vacuum forces to the first and second side panels to hold the first and second side panels in contact with the first and second folding members.

14. The method of claim 13, wherein the vacuum forces are applied only to the second end regions of the first and second side panels.

15. The method of claim 1, wherein the crotch region is transferred from the drum before the first and second waist regions.

16. The method of claim 1, wherein the first conveyor is a folding drum.

17. A method for assembling disposable diaper pants, each diaper pant comprising a chassis, a first side panel, and a second side panel, each chassis comprising a topsheet, a backsheet, and an absorbent core disposed between the topsheet and the backsheet, each chassis comprising a first waist region longitudinally opposed to a second waist region, and a crotch region located between the first and second waist regions, and having a longitudinal axis and a lateral axis, the first and second side panels joining the first waist region and the second waist region to form a waist opening and a pair of leg openings, the method comprising the steps of:
advancing the first and second side panels in a machine direction on a first conveyor;
transferring the first and second side panels to a drum comprising an outer surface, a first folding member, and a second folding member, wherein the first and second side panels extend laterally outward from a central region of the outer surface with the first side panel positioned on the first folding member and the second side panel positioned on the second folding member;
advancing the chassis in a machine direction on a first conveyor;
folding the chassis about the lateral axis to position the second waist region into a facing relationship with the first waist region;
transferring the folded chassis, with the crotch region positioned as the leading portion of the folded chassis, directly to the drum, wherein the backsheet of the first waist region is in direct contact with an outer surface of the drum and first end regions of the first and second side panels;
moving the first folding member and the second folding member toward each other and radially outward relative to the outer surface of the drum to position second end regions of the first and second side panels in contact with the second waist region of the chassis; and
connecting the second end regions of the first and second side panels with the second waist region.

18. The method of claim 17, wherein the second end regions of the first and second side panels are permanently connected with the second waist region.

19. The method of claim 17, wherein the second end regions of the first and second side panels are refastenably connected with the second waist region.

20. The method of claim 17, further comprising the step of holding the second waist region of the chassis in the facing relationship with the first waist region before and after the step of transferring.
